(19) United States
(12) Patent Application Publication
(10) Pub. No.: US 2024/0378679 A1
(43) Pub. Date: Nov. 14, 2024

(54) DOCUMENT GENERATION INFERENCES TRIGGERED BY POLICY TRANSACTIONS

(71) Applicant: State Farm Mutual Automobile Insurance Company, Bloomington, IL (US)

(72) Inventors: Jeffrey Kennedy, Dallas, TX (US); Renee E Titus, North St Paul, MN (US); Michael McDermott, Murphy, TX (US); Jason Smith, Double Oak, TX (US); Mary Palmore, Royse City, TX (US)

(21) Appl. No.: 18/658,801

(22) Filed: May 8, 2024

Related U.S. Application Data
(60) Provisional application No. 63/465,171, filed on May 9, 2023.

(51) Int. Cl. G06Q 40/08; G06N 5/04

(52) U.S. Cl. CPC G06Q 40/08; G06N 5/04

(57) ABSTRACT

A document inference system applies document inference rules to policy operation data received from a separate policy management system, to determine which types of documents are to be generated in response to an operation performed within the policy management system. The document inference system also converts user-provided natural language definitions of conditions of document inference rules into document inference rules that the document inference system applies to policy operation data received from the policy management system.

### RELATED APPLICATIONS

This U.S. patent application claims priority to provisional U.S. Patent Application No. 63/465,171, entitled “DOCUMENT GENERATION INFERENCES TRIGGERED BY POLICY TRANSACTIONS,” filed on May 9, 2023, the entirety of which is incorporated herein by reference.

### TECHNICAL FIELD

The present disclosure relates to automatically generating documents associated with insurance policies, and more particularly to a system configured to determine which documents to generate in response to insurance policy operations that have been performed within a policy management system.

### BACKGROUND

Individuals, companies, and other entities often hold insurance policies with insurance companies. For example, insurance policies can include automobile insurance policies, home insurance policies, and other types of insurance policies. Insurance companies can use computer-implemented policy management systems to store information about insurance policies, create new insurance policies, change existing insurance policies, and/or otherwise manage insurance policies.

When operations are performed within a policy management system, such as operations to change insurance policies, operations to renew insurance policies, and/or other types of actions, transactions, or operations, documents associated with the operations can be generated. The generated documents can be provided to insured parties, users of the policy management system, and/or other entities. Such documents can include forms, letters, and/or other types of documents.

For example, an insurance policy operation may involve a modification to an existing insurance policy associated with an insured party. An endorsement document that modifies terms of a previous insurance contract may accordingly be generated based on the modification to the insurance policy. A letter explaining the modification to the insurance policy may also be generated and sent to the insured party.

Some policy management systems include native document tools, built into the policy management systems, that may indicate which types of documents are to be generated in response to insurance policy operations. However, such native document tools often determine which documents to generate based on logic that has been hard-coded into source code of the policy management systems. Additionally, such native document tools may be hard-coded to generate a set of standardized documents, such as standardized forms, and may not natively permit generation of custom types of documents or the generation of combinations of standardized documents and custom documents. Accordingly, it can be difficult to change the hard-coded logic used by such native document tools to adjust which types of documents are to be generated in response to particular types of insurance policy operations, add logic that causes new types of documents to be generated in response to particular types of insurance policy operations, and/or otherwise change how the native document tools operate.

For instance, to change the logic used by a native document tool of a policy management system and/or to adjust which types of forms are generated by the native document tool, a programmer may need to edit source code, re-compile a new version of the policy management system, test the new version of the policy management system, and deploy the new version of the policy management system into production. Accordingly, implementing even small changes to the logic used by a native document tool to determine which documents are to be generated in response to insurance policy operations may take significant time and require source code changes made by programmers who have programming experience.

As such, native document tools of policy management systems can be inflexible and inefficient. For example, a native document tool of a policy management system may be hard-coded to indicate that a particular type of document should be generated in response to a particular type of insurance policy operation that impacts insurance policies in the state of Ohio. However, if insurance laws of the state of Illinois are changed such that the same type of document should also be generated in response to the same or similar types of insurance policy operations that impact insurance policies in the state of Illinois, the native document tool may not recommend generation of that type of document for insurance policy operations associated with the state of Illinois until a programmer is able to make corresponding changes to the source code of the policy management system and a corresponding new version of the policy management system is deployed. These issues may be compounded because there may be relatively frequent changes to laws in different states or jurisdictions, changes to business processes, and/or other changes that impact which documents should be generated in response to corresponding insurance policy operations, and each individual change impacting which documents are to be generated may require corresponding changes to the source code of the policy management system.

The example systems and methods described herein may be directed toward mitigating or overcoming one or more of the deficiencies described above.

### SUMMARY

Described herein are systems and methods for generating and using document inference rules to determine which documents, if any, are to be generated in response to an insurance policy operation performed within a policy management system. A document inference system, separate from the policy management system, can apply the document inference rules to policy operation data associated with an insurance policy operation performed within the policy management system. If the policy operation data satisfies conditions of document inference rules, the document inference system can generate a document inference indicating document types associated with the satisfied document inference rules. The document inference can indicate which types of documents will be generated by a document generation system in response to the insurance policy operation. The document inference system can also display and accept natural language definitions of conditions of document inference rules from users, and convert the natural language definitions into document inference rules that can be applied to policy operation data. Accordingly, users who may not have programming experience can use natural language elements to generate and/or edit document inference rules used by the document inference system.

According to a first aspect, a computer-implemented method includes receiving, by a document inference system executed by a computing system, user input indicating a natural language definition of a condition corresponding to a document type. The computer-implemented method also includes converting, by the document inference system, the natural language definition of the condition into a document inference rule that is applicable by a decision engine of the document inference system. The computer-implemented method further includes receiving, by the document inference system, operation data associated with an operation performed within a management system that is separate from the document inference system. The computer-implemented method additionally includes determining, by the decision engine of the document inference system, that the operation data satisfies the document inference rule associated with the document type. The computer-implemented method also includes generating, by the document inference system, based on determining that the operation data satisfies the document inference rule, a document inference that identifies the document type.

According to a second aspect, a computing system includes one or more processors and memory. The memory stores computer-executable instructions associated with a document inference system. The computer-executable instructions, when executed by the one or more processors, cause the one or more processors to receive, from a management system separate from the document inference system, operation data associated with an operation performed within the management system. The computer-executable instructions also cause the one or more processors to determine that the operation data satisfies conditions of a document inference rule associated with a document type. The computer-executable instructions further cause the one or more processors to generate, in response to determining that the operation data satisfies the conditions of the document inference rule, a document inference that identifies the document type. The computer-executable instructions additionally cause the one or more processors to provide the document inference to at least one of the management system or a document generation system configured to generate an instance of the document type in response to the operation performed within the management system.

According to a third aspect, one or more non-transitory computer-readable media store computer-executable instructions associated with a document inference system. The computer-executable instructions, when executed by the one or more processors, cause the one or more processors to receive, from a management system separate from the document inference system, operation data associated with an operation performed within the management system. The computer-executable instructions also cause the one or more processors to determine that the operation data satisfies conditions of a document inference rule associated with a document type. The computer-executable instructions further cause the one or more processors to generate, in response to determining that the operation data satisfies the conditions of the document inference rule, a document inference that identifies the document type. The computer-executable instructions additionally cause the one or more processors to provide the document inference to at least one of the management system or a document generation system configured to generate an instance of the document type in response to the operation performed within the management system.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example of a system that is configured to automatically generate documents in response to insurance policy operations performed within a policy management system.

FIG. 2 shows an example of a document view of a user interface associated with a rule manager of a document inference system.

FIG. 3 shows an example of a rule summary view of a user interface associated with the rule manager.

FIG. 4 shows an example of a rule editor view of a user interface associated with the rule manager.

FIG. 5 shows an example of an expanded rule editor view of a user interface associated with the rule manager.

FIG. 6 shows a flowchart illustrating an example method that can be used to generate document inference rules from natural language input provided by users.

FIG. 7 shows a flowchart illustrating an example method that can be used to generate a document inference, and any corresponding documents, in response to an insurance policy operation performed within a policy management system.

FIG. 8 shows an example system architecture for a computing system that can execute one or more elements of the system described herein.

### DETAILED DESCRIPTION

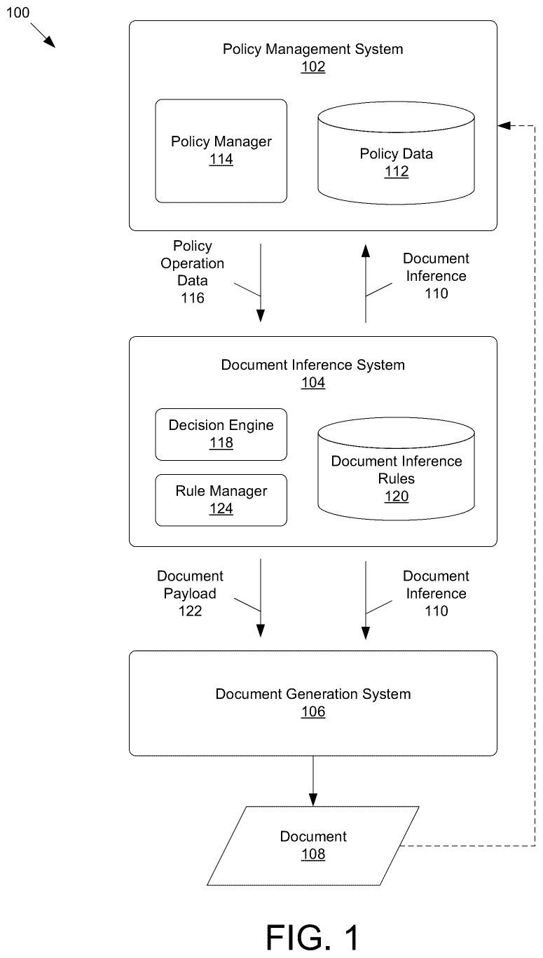

FIG. 1 shows an example of a system 100 that is configured to automatically generate documents in response to insurance policy operations performed within a policy management system 102. The documents can include forms, letters, and/or other types of documents associated with the insurance policy operations, such as documents that explain the insurance policy operations, changes to insurance policies and/or other data caused by the insurance policy operations, and/or other types of information associated with the insurance policy operations. In some examples, such documents can be physically and/or electronically sent to recipients, such as insured parties or other parties associated with insurance policies. In other examples, such documents may be displayed electronically via a user interface, as discussed further below.

The system 100 can include the policy management system 102, a document inference system 104, and a document generation system 106. The policy management system 102 can be configured to manage information about insurance policies associated with an insurance company. When an operation is performed within the policy management system 102 in association with an insurance policy, for instance to add new insurance coverage, terminate insurance coverage, or adjust insurance coverage, the document inference system 104 can automatically determine, or “infer,” which types of documents, if any, correspond to the operation performed within the policy management system 102. The document inference system 104 can generate a corresponding document inference 110, such as data that identifies the inferred types of documents. For example, the document inference 110 may indicate names of document types, numeric identifiers of document types, and/or other types of document type identifiers. In some examples, the document inference system 104 may also cause the document generation system 106 to automatically generate instances of the inferred types of documents indicated by the document inference 110, such that the generated documents can be sent and/or displayed.

For example, as shown in FIG. 1, the document generation system 106 can generate a document 108, based at least in part on a document inference 110 determined by the document inference system 104 in response to an insurance policy operation performed within the policy management system 102. The document 108 can be an instance of a type of document identified by the document inference 110 generated by the document inference system 104, such as an instance of a standardized document type, an instance of a custom document type, or an instance of another type of document. Accordingly, the document 108 associated with the performed insurance policy operation, generated based at least in part on the document inference 110 determined by the document inference system 104, can be sent to one or more recipients and/or can be displayed via the policy management system 102.

The policy management system 102 can be a computer-implemented application or system that manages policy data 112 associated with insurance policies. The policy data 112 can include digital records, associated with insurance policies, that are stored in one or more databases or other data repositories that are accessible by elements of the policy management system 102.

The policy management system 102 can have a policy manager 114 that accesses policy data 112 associated with insurance policies, and/or performs operations associated with insurance policies and corresponding policy data 112. For example, the policy manager 114 may access and/or edit policy data 112 associated with insurance policies to perform corresponding operations, such as operations to renew insurance policies, operations to create new insurance policies, operations to adjust insurance coverage provided by insurance policies, operations to terminate insurance policies, and/or other types of actions, transactions, or other operations associated with new and/or existing insurance policies.

In some examples, the policy manager 114 can have a user interface that allows users to view, edit, and/or otherwise manage policy data 112 associated with insurance policies. Such users may be insurance agents, claims adjustors, insured parties, and/or other types of users. As an example, the policy manager 114 may be accessed via a website, web application, portal, or other system that an insurance agent can use to view, edit, and/or otherwise manage policy data 112, for instance by providing input to initiate transactions or other operations associated with insurance policies managed by the insurance agent. As another example, an insured party associated with an insurance policy may access the policy manager 114 via an account management website, mobile application, or other system that provides tools the insured party can use to initiate transactions or other operations associated with the insurance policy. Accordingly, in these examples, the policy manager 114 can perform operations, such as transactions or other actions that access, create, edit, and/or otherwise manage policy data 112 associated with insurance policies, in response to user input.

The policy manager 114 may also, or alternately, perform batch processes or other automatic operations to automatically perform operations associated with insurance policies. For example, the policy manager 114 may be configured to automatically edit policy data 112 in association with automatic renewals of insurance policies at predetermined intervals, and/or to perform other types of automated operations.

In some examples, when an operation associated with an insurance policy is performed via the policy management system 102, the document generation system 106 may use a document inference 110 to generate instances of one or more types of documents that correspond to the performed operation, as described further below. In some examples, generated documents may be displayed via a user interface of the policy management system 102, such as a user interface of the policy manager 114. In other examples, generated documents can be sent to one or more recipients, for instance physically via mail or other physical delivery services, and/or electronically via email, text messages, digital messaging systems, and/or other electronic delivery services. As discussed further below, in other examples a document inference 110 associated with an operation performed via the policy management system 102 may identify one or more types of documents that correspond to the performed operation, but generation of corresponding instances of those types of documents by the document generation system 106 may be suppressed.

As described herein, the document inference system 104 can generate a document inference 110 to indicate which types of documents correspond to an operation that has been performed in the policy management system 102. When an operation associated with an insurance policy is performed via the policy management system 102, the policy management system 102 can provide corresponding policy operation data 116 associated with the performed operation to the document inference system 104.

The document inference system 104 can have a decision engine 118 that uses document inference rules 120 to, based on the policy operation data 116 associated with the operation, generate the document inference 110 associated with the operation. The document inference 110 can be a notification or other type of data indicating which types of documents, if any, correspond to the operation performed via the policy management system 102. The document inference 110 may accordingly indicate types of documents that are to be generated by the document generation system 106, or could be generated by the document generation system 106, in response to the operation performed via the policy management system 102.

In some examples, a document inference 110 generated by the document inference system 104 may trigger the document generation system 106 to generate instances of all of the types of documents identified by the document inference 110. However, in other examples the document inference 110 may indicate whether or not the document generation system 106 should actually generate instances of particular types of documents identified by the document inference 110. For example, the document inference 110 may have a suppression indicator, such as a field, a flag, a header value, or other type of data indicating whether or not the document generation system 106 should actually generate an instance of a type of document identified by the document inference 110. In these examples, the document inference rules 120 may include suppression rules defining situations in which, although one or more other document inference rules 120 may determine an inferred document type, an actual instance of the inferred document type should not be generated by the document generation system 106.

As an example, the document generation system 106 may have generated an instance of a particular document type that was sent to a particular policyholder at a first time during a policy period in response to a first operation performed via the policy management system 102. Document inference rules 120 may indicate that a second operation performed via the policy management system 102 during the same policy period in association with the particular policyholder would lead to generation of a second instance of the same particular document type. However, the document inference rules 120 may also include a suppression rule indicating that, because the second operation was performed during the same policy period as the first operation, the second instance of the particular document type would likely be identical to the already-generated instance of the particular document type. Accordingly, to avoid generation of duplicate documents, the document inference system 104 may generate a document inference 110 that identifies the particular document type in association with performance of the second operation, but indicates that actual generation of a second instance of the particular document type should be suppressed.

The document inference system 104 can also use the policy operation data 116 provided by the policy management system 102, and/or additional policy operation data 116 or other associated policy data 112 retrieved from the policy management system 102, to determine a document payload 122 for one or more types of documents indicated by the document inference 110 that are to be generated. For instance, for a type of document indicated by the document inference 110 that is to be generated, the document generation system 106 may use a corresponding document payload 122 to generate an instance of that type of document. The document payload 122 for a document type can include a document template, values for placeholders of a document template to include in the instance of the document type, pre-written sentences, paragraphs, or other portions of content to include in the instance of the document type, arrangements and/or selections of pre-written portions of content to include in the instance of the document type, and/or other content that the document generation system 106 can use to generate the instance of the document type.

For example, the document inference system 104 can use document inference rules 120 and/or other types of rules to determine, based on initial policy operation data 116 provided by the policy management system 102, additional policy operation data 116, and/or other policy data 112 retrieved from the policy management system 102, one or more paragraph inferences indicating which paragraphs or other content elements are to be included in an instance of a corresponding document. The document inference system 104 may also use the policy operation data 116 and/or other policy data 112 to determine values to use to fill in placeholders within the paragraphs or other content elements. For example, the document inference system 104 may also use the policy operation data 116 and/or other policy data 112 to determine names, dates, addresses, insurance policy information, and/or other information to be expressed in generated documents. The document payload 122 can accordingly indicate paragraph inferences indicating particular paragraphs and/or other content elements to include in the document, as well as particular values to express within the document.

The document inference system 104 can provide the document inference 110 and/or the document payload 122 to the document generation system 106. Accordingly, in some examples the document generation system 106 can generate one or more types of documents, indicated by the document inference 110, that include content based on the document payload 122. In some examples, the document inference system 104 can provide the document inference 110 to the document generation system 106 along with, or as part of, the document payload 122. In other examples, the document inference system 104 can provide the document inference 110 and the document payload 122 to the document generation system 106 separately and/or at different times.

In some examples, the document inference system 104 may determine not to provide the document inference 110 to the document generation system 106, for instance if one or more suppression indicators in the document inference 110 indicate that the document generation system 106 should not actually generate any documents based on the document inference 110. In other examples, the document inference system 104 may provide the document inference 110 to the document generation system 106, but include one or more suppression indicators indicating whether or not the document generation system 106 should actually generate instances of one or more corresponding document types identified by the document inference 110.

The document inference system 104 may also, or alternately, provide the document inference 110 to the policy management system 102. Accordingly, the document inference 110 may indicate, to the policy management system 102, one or more types of documents that were inferred by the document inference system 104 based on an operation performed via the policy management system 102, and/or whether instances of those types of documents will be generated by the document generation system 106.

In some examples, the policy management system 102 may provide additional policy operation data 116 or other policy data 112, associated with one or more types of documents indicated by the document inference 110, to the document inference system 104 in response to receipt of the document inference 110. The document inference system 104 can use the additional policy operation data 116 or other policy data 112, instead of or in addition to the initial policy operation data 116 used to generate the document inference 110, to generate the corresponding document payload 122 for the document generation system 106.

For instance, initial policy operation data 116 may include a relatively limited amount of information about an insurance policy operation that has been performed via the policy management system 102. The initial policy operation data 116 may be sufficient for the document inference system 104 to apply the document inference rules 120 and generate a corresponding document inference 110. However, additional policy operation data 116, provided by the policy management system 102 at a later time in response to the document inference 110 generated by the document inference system 104, can include additional information about the insurance policy operation that the document inference system 104 can use to generate the document payload 122.

In other examples, the policy management system 102 may use the document inference 110 to display, in a user interface, an indication that one or more documents will be generated by the document generation system 106, but may not yet be available. The policy management system 102 may later present the documents in the user interface, once the documents have been generated and provided to the policy management system 102. As an example, the document inference system 104 may infer that an endorsement document associated with an insurance policy should be generated in response to performance of an operation associated with that insurance policy via the policy management system 102. The document inference 110, indicating that the endorsement document will be generated in response to the operation performed via the policy management system 102, can cause a user interface of the policy management system 102 to display a placeholder indicating that an endorsement document will be generated but is not yet available. Once the document generation system 106 generates the endorsement document, for example based on the document payload 122 provided by the document inference system 104, the user interface of the policy management system 102 may replace the placeholder for the endorsement document with copy of, or a link to, the generated endorsement document.

In some examples, if a document inference 110 indicates that actual generation of a document type by the document generation system 106 will be suppressed, the policy management system 102 may use the document inference 110 to display an indication of that document type, and/or track the document type, in association with an operation performed via the policy management system 102. For example, the document inference system 104 may use document inference rules 120 to infer that a policy summary document associated with an insurance policy could be generated in response to performance of an operation associated with that insurance policy via the policy management system 102. However, the document inference system 104 may also use other document inference rules 120, such as one or more suppression rules, to determine that actual generation of such a policy summary document by the document generation system 106 should be suppressed, for instance because an identical policy summary document was already recently generated for the insurance policy. The document inference system 104 may generate a document inference 110 that indicates that the operation performed via the policy management system 102 led to an inference of a corresponding policy summary document, but include a suppression indicator in the document inference 110 to indicate that generation of a policy summary document is being suppressed. Accordingly, the policy management system 102 may display an indication in a user interface that the operation performed via the policy management system 102 is associated with an inference of the policy summary document type, but that generation of an actual policy summary document is being suppressed.

As discussed above, in some examples the document inference 110 generated by the document inference system 104 may include a suppression indicator to indicate whether or not the document generation system 106 should actually generate instances of one or more types of documents identified in the document inference 110. In other examples, the document inference system 104 may include a similar suppression indicator in a document payload 122 that corresponds to a previously-determined document inference 110, for example if additional policy operation data 116 received from the policy management system 102 after generation of the document inference 110 indicates that the document generation system 106 should not actually generate one or more types of documents identified by the document inference 110.

In still other examples, the document inference system 104 may provide an initial version of a document inference 110 to the policy management system 102 so that additional policy operation data 116 received from the policy management system 102 in response to the initial version of a document inference 110. The document inference system 104 may then use the additional policy operation data 116 to determine to whether to add a suppression indicator to the document inference 110 in association with one or more identified document types before providing the document inference 110 to the document generation system 106.

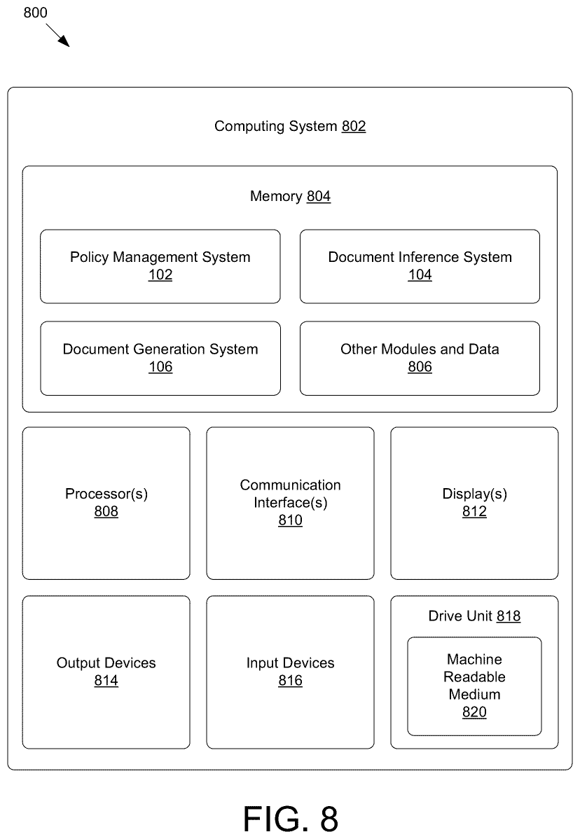

The document inference system 104 can be a component that executes separately from the policy management system 102. For example, the document inference system 104 can be a separate computer-implemented application or system that executes independently from the policy management system 102. As an example, the document inference system 104 and the policy management system 102 can execute as separate applications and/or on different computing systems. The document inference system 104 may also be separate from the document generation system 106, or may be a component of the document generation system 106 that is itself separate from the policy management system 102. An example system architecture for a computing system that may execute one or more elements of the system 100, such as one or more of the policy management system 102, the document inference system 104, and the document generation system 106, is shown in FIG. 8, and is discussed further below with reference to that figure.

In some examples, the policy management system 102 may have a native document system that is designed, based on logic hard-coded into source code of the policy management system 102, to determine which documents to generate based on corresponding operations performed within the policy management system 102. Such a native document system may also be hard-coded to cause generation of instances of a predefined set of standardized documents. However, in these examples, the native document system of the policy management system 102 can be disabled, and the policy management system 102 can instead be configured to provide policy operation data 116 associated with insurance policy operations, performed via the policy management system 102, to the separate document inference system 104.

Accordingly, the separate document inference system 104 can use the document inference rules 120 to determine, based on the provided policy operation data 116, which documents, if any, are to be generated in response to insurance policy operations performed within the policy management system 102. For example, the document inference rules 120 may indicate that custom types of documents should be generated in response to corresponding insurance policy operations performed within the policy management system 102. The document inference rules 120 applied via the document inference system 104 may result in generation of different types of documents, and/or generation of documents in different situations, than may otherwise be generated via a hard-coded native document system of the policy management system 102.

As described further below, the document inference rules 120 can be created and/or edited by users without using a programming language or editing source code. As such, users who may not have programming skills or experience can adjust the document inference rules 120 used by the separate document inference system 104 to define conditions of situations in which particular types of documents are to be generated, instead of changing source code of the policy management system 102 to adjust the logic of a native document system that is hard-coded into the policy management system 102.

The policy management system 102 can have one or more application programming interfaces (APIs), data sharing systems, or other interfaces that the policy management system 102 can use to provide the policy operation data 116 to the separate document inference system 104. In some examples, such interfaces may also allow the policy management system 102 to provide policy data 112 and/or other types of data to the document inference system 104, and/or to receive the document inference 110 and/or other types of data from the document inference system 104.

The policy management system 102 can provide policy operation data 116, associated with insurance policy operations, to the document inference system 104 synchronously and/or asynchronously relative to performance of the insurance policy operations via the policy management system 102. Synchronous policy operation data 116 can be provided as notifications or other messages that are directly sent by the policy management system 102 to the document inference system 104 when corresponding insurance policy operations are performed within the policy management system 102. Asynchronous policy operation data 116 can be published to message tables or other data sharing systems when corresponding insurance policy operations are performed within the policy management system 102, such that the document inference system 104 can retrieve the published asynchronous policy operation data 116 from the policy management system 102 at a later point in time.

As an example, the policy management system 102 may provide the document inference system 104 with synchronous policy operation data 116 associated with an insurance policy operation, as part of or substantially immediately after performance of the insurance policy operation within the policy management system 102. The synchronous policy operation data 116 can be a message that indicates a type of the insurance policy operation, attributes of the insurance policy operation, metadata about the insurance policy operation, and/or other information about the insurance policy operation. The document inference system 104 can apply the document inference rules 120 to the synchronous policy operation data 116, to infer which types of documents correspond to the insurance policy operation performed via the policy management system 102. The document inference system 104 can return the document inference 110, identifying types of documents, if any, that correspond to the insurance policy operation, to the policy management system 102.

The policy management system 102 may publish additional policy operation data 116 and/or related policy data 112, which may include more detailed information about the insurance policy operation than was included in the synchronous policy operation data 116, to message tables or other data sharing systems as asynchronous policy operation data 116. In some examples, the types of additional information about the insurance policy operation that are published by the policy management system 102 as asynchronous policy operation data 116 may be based at least in part on the types of documents indicated by the document inference 110. The document inference system 104 can then access or retrieve the published asynchronous policy operation data 116 associated with the insurance policy operation. The document inference system 104 can use the asynchronous policy operation data 116, in addition to or instead of the earlier synchronous policy operation data 116, to generate the document payload 122 provided to the document generation system 106. In some examples, the document inference system 104 may also, or alternately, use asynchronous policy operation data 116 to determine whether to add one or more suppression indicators to a version of the document inference 110, and/or a corresponding document payload 122, provided to the document generation system 106 in order to suppress actual generation of corresponding document types identified in the document inference 110.

The document inference system 104 can have a database or other repository of document inference rules 120. For example, the document inference rules 120 can be stored in a relational database. The document inference rules 120 can be expressed as source code or other computer-readable instructions or data that can be used by the decision engine 118 to evaluate policy operation data 116. In some examples, data defining the document inference rules 120, such as attribute-value pairs associated with the document inference rules 120, can be stored in a JavaScript Object Notation (JSON) format, an Extensible Markup Language (XML) format, or other data formats.

Although the document inference rules 120 can be stored and/or expressed as JSON data or other computer-readable data that may be at least partially readable by humans, the document inference rules 120 may be stored and/or applied by the decision engine 118 in a format that may be relatively difficult for humans who do not have programming experience to understand and/or edit. Accordingly, as discussed further below the document inference system 104 can have a rule manager 124 that can translate user-provided natural language definitions of the document inference rules 120 into JSON data, source code, or other computer-readable data that defines the document inference rules 120 and that can be used by the decision engine 118 to automatically evaluate policy operation data 116. Accordingly, users who may not have programming experience can provide natural language definitions via the rule manager 124 to create and/or edit document inference rules 120.

A document inference rule can define a set of conditions that, if satisfied by policy operation data 116 associated with an insurance policy operation performed via the policy management system 102, indicate that a particular type of document corresponds to the insurance policy operation. Accordingly, if policy operation data 116 satisfies the conditions defined by a document inference rule associated with a particular document type, the document inference system 104 may identify that particular document type in a corresponding document inference 110.

The document inference rules 120 may also include suppression rules defining conditions that, if satisfied by policy operation data 116 and/or other data associated with insurance policy operations, indicate that generation of instances of corresponding types of documents should be suppressed. If policy operation data 116 associated with an insurance policy operation performed via the policy management system 102 satisfies the conditions defined by a suppression rule associated with a particular document type, the document inference system 104 may indicate in a document inference 110 or other data that generation of an instance of that particular document type in response to performance of the insurance policy operation should be suppressed. Accordingly, satisfaction of a document inference rule may trigger generation of a corresponding instance of the document type associated with the document inference rule, unless a suppression rule indicates that generation of an instance of that document type should be suppressed.

The decision engine 118 of the document inference system 104 can accordingly apply the document inference rules 120 to an instance of policy operation data 116 to determine which, if any, of the document inference rules 120 are satisfied by the instance of policy operation data 116. The document inference rules 120 can be associated with corresponding types of documents, such as standardized document types, custom document types, and/or other document types. Accordingly, by determining which document inference rules 120, if any, are satisfied by the instance of policy operation data 116, the document inference 110 generated by the decision engine 118 can accordingly identify the types of documents that correspond to the satisfied document inference rules 120. The document inference 110 may, in some examples, also indicate whether instances of the identified types of documents should, or should not, be generated by the document generation system 106, based on applicable suppression rules within the document inference rules 120.

When the decision engine 118 of the document inference system 104 applies document inference rules 120 to policy operation data 116 associated with an insurance policy operation performed via the policy management system 102 and generates the corresponding document inference 110, the document inference system 104 can provide the document inference 110 to either or both of the policy management system 102 and the document generation system 106. The document inference 110 can indicate which types of documents correspond to the insurance policy operation that has been performed via the policy management system 102. The document inference 110 can thereby notify the policy management system 102 and/or the document generation system 106 about which types of documents will be generated in response to performance of the insurance policy operation via the policy management system 102, and/or that generation of instances of particular types of documents corresponding to the performed insurance policy operation is being suppressed.

The document inference system 104 can also use the policy operation data 116, and/or additional policy operation data 116 or other policy data 112, to generate the document payload 122 that the document generation system 106 can use to actually generate instances of one or more types of documents identified in the document inference 110. The document payload 122 can define values and/or other types of content that the document generation system 106 can use to generate instances of types of documents. As an example, the document payload 122 can define particular values that the document generation system 106 can use to fill in placeholders of a document template or otherwise is to express in a document. As another example, the document payload 122 can include paragraph inferences and/or other content inferences indicating which particular content elements the document generation system 106 is to include in an instance of a document, such as particular elements of a document template, particular pre-written paragraphs or other pre-prepared content elements, and/or other identified content elements. The document generation system 106 can accordingly use paragraph inferences, other content inferences, and/or particular values provided in the document payload 122 to generate instances of the document types indicated by the document inference 110.

As discussed above, the document inference rules 120 used by the document inference system 104 can be generated, edited, and/or viewed via the rule manager 124 of the document inference system 104. The rule manager 124 can have a user interface that allows a user to view document inference rules 120, generate new document inference rules 120, and/or edit existing document inference rules 120.

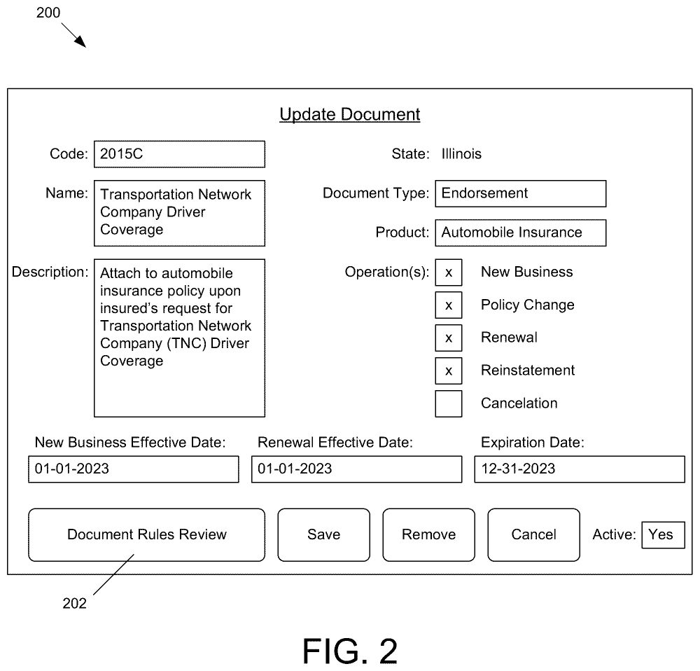

The user interface of the rule manager 124 can present and/or accept natural language expressions of conditions for the document inference rules 120. As discussed above, the document inference rules 120 may indicate conditions associated with types of documents that correspond to insurance policy operations, and/or conditions in which generation of instances of such types of documents should or should not be suppressed. The natural language expressions of the conditions of the document inference rules 120 can be distinct from JSON data, source code expressions, and/or other underlying machine-readable data that define the document inference rules 120. For example, as discussed further below with respect to FIGS. 2-5, the user interface of the rule manager 124 can present user-selectable options, text fields, menus, and/or other user interface elements that allow users to create and/or edit natural language definitions of conditions of document inference rules 120. The user interface of the rule manager 124 may also present natural language definitions of existing document inference rules 120, such that users can view and/or edit the natural language definitions of existing document inference rules 120.

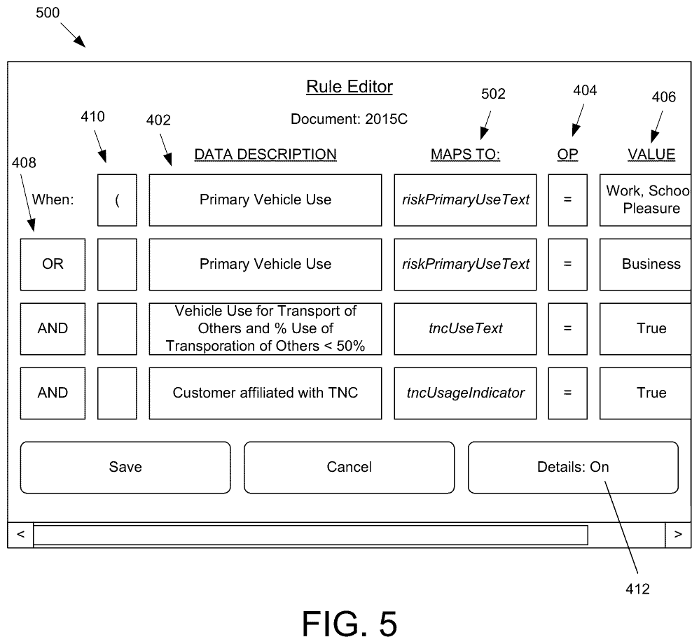

The natural language definitions of document inference rules 120 can include text, numbers, operators, and/or other types of content entered by users. For example, natural language definitions of document inference rules 120 can include text, such as pre-filled text descriptions that can be selected by users and/or freeform text entered by users. The natural language definitions may also include logical operators and/or other user-selected or user-provided characters or operators, which users may select or enter via the rule manager 124 as shown in FIGS. 4 and 5. Accordingly, although the natural language definitions of document inference rules 120 may be readable and understandable by users who may not have programming experience, the natural language definitions may include characters or other symbols in addition and/or instead of words. For instance, a natural language definition may include the character “=” instead of the words “equal to.”

The rule manager 124 can translate natural language definitions of existing document inference rules 120 into underlying representations of the conditions associated with the document inference rules 120 that can be applied to policy operation data 116 by the decision engine 118. For example, based on user-entered natural language definitions of conditions of a document inference rule, the rule manager 124 can identify data elements of policy operation data 116 that correspond the user-defined conditions and that can be identified and inspected by the decision engine 118. The rule manager 124 can also identify conditional operators and/or other operators indicated by the user-defined conditions, and generate corresponding JSON data, source code, and/or other computer-readable data for the document inference rule that can be applied by the decision engine 118 to evaluate data elements in the policy operation data 116. For example, when a user of the rule manager 124 enters a natural language definition of a new document inference rule, the rule manager 124 can translate the natural language definition of a new document inference rule into conditional statements, attribute-values pairs of JSON data, and/or other computer-readable data that can be automatically applied to policy operation data 116 by the decision engine 118 of the document inference system 104.

In some examples, the rule manager 124 can be configured with mappings between natural language descriptions of data types or other values that can be accepted as user input via the rule manager 124, and corresponding attribute names, field names, or other identifiers of corresponding information types used within policy operation data 116. For instance, the rule manager 124 may have a schema of identifiers for data types that may be used by the policy management system 102 within policy operation data 116, and can have mapping data that maps the schema of the identifiers of data types within policy operation data 116 to corresponding natural language descriptions that can be used and/or presented to users via the rule manager 124. As such, a user who does not know underlying field names for data types that the policy management system 102 is configured to use within policy operation data 116 can nevertheless use corresponding natural language descriptions to view and/or edit conditions of document inference rules 120 via the rule manager 124. The rule manager 124 may use mapping data to convert the user-entered natural language descriptions of conditions of document inference rules 120 into JSON data, source code, or other computer-readable data that use identifiers of corresponding data types or other information used within policy operation data 116 generated and/or provided by the policy management system 102.

Accordingly, because the rule manager 124 allows users to use natural language inputs to define and/or edit document inference rules 120, users who may not have programming experience that might otherwise be needed to adjust hard-coded logic of a native document system of the policy management system 102 can nevertheless define and/or edit document inference rules 120 used by the separate document inference system 104. Such users can use the rule manager 124 to provide natural language input that the rule manager 124 translates into document inference rules 120 that can be used immediately and/or directly by the decision engine 118. As such, users can quickly generate and/or adjust document inference rules 120 used by the decision engine 118, for instance to quickly test how a new document inference rule performs with respect to actual policy operation data 116, to quickly add new document inference rules 120, quickly adjust conditions of existing document inference rules 120, and/or otherwise add or adjust document inference rules 120 to change which documents are generated in response to insurance policy operations performed via the policy management system 102, without having to manually edit source code or other computer-readable data that defines the document inference rules 120, edit source code of the policy management system 102 and/or re-compile the policy management system 102, or otherwise perform operations that may involve programming knowledge or experience. FIGS. 2-5, discussed further below, show examples of user interface views associated with the rule manager 124 that users can use to define and/or edit document inference rules 120 associated with types of documents.

FIG. 2 shows an example of a document view 200 of a user interface associated with the rule manager 124. The document view 200 can display a summary of information associated with a type of document that may be generated in response to an insurance policy operation performed within the policy management system 102. For example, the document view 200 may display one or more identifiers of the document type, such as a code, a name, and/or other identifiers. The document view 200 may also display natural language descriptions of the document type and/or content expressed via the document type. The document view 200 may also display a product identifier or type associated with the document type, a state or other jurisdiction relevant to the document type, one or more types of insurance policy operations that are relevant to the document type, effective dates for new business and renewals associated with the document type, an expiration date associated with the document type, and/or any other information about the document type.

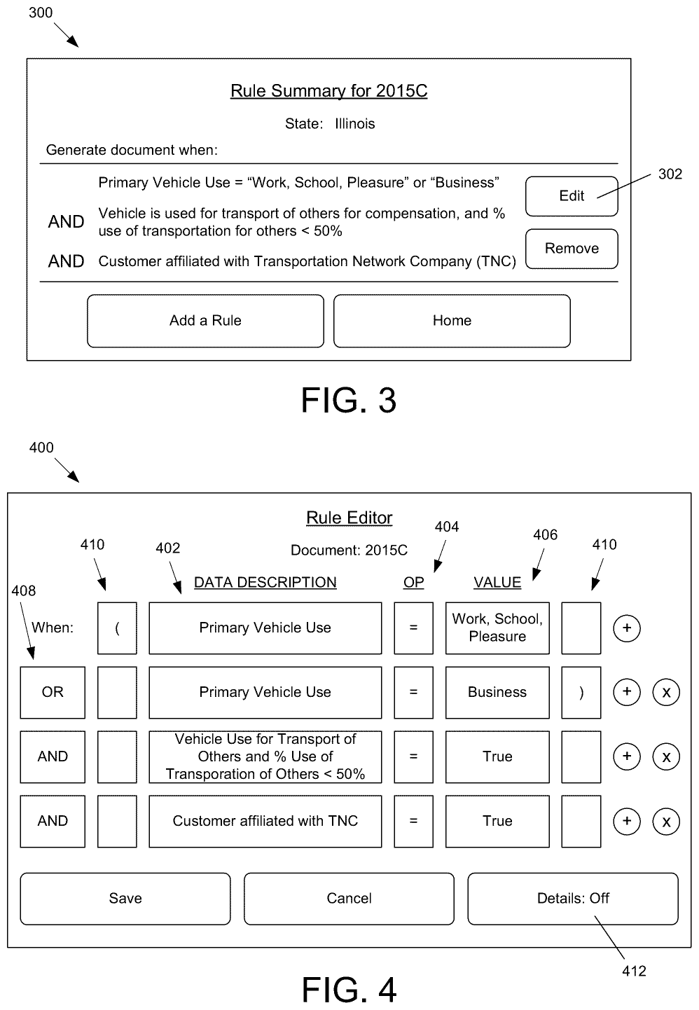

In the document view 200, one or more types of information may be editable by users. For example, a user may change the description of the document type, adjust which types of insurance policy operations are relevant to the document type, and/or edit other information associated with the document type via the document view 200 in the user interface of the rule manager 124. The document view 200 can also include a document rules review option 202. A user can select the document rules review option 202 to view and/or edit a document inference rule associated with the document type, as discussed below with respect to FIGS. 3-5.

FIG. 3 shows an example of a rule summary view 300 of a user interface associated with the rule manager 124. In some examples, the rule summary view 300 shown in FIG. 3 can be displayed in the user interface of the rule manager 124 when a user selects the document rules review option 202 shown in FIG. 2. The rule summary view 300 can display a set of conditions of a document inference rule that, if satisfied by policy operation data 116 associated with an insurance policy operation performed via the policy management system 102, indicate that an instance of the document type associated with document inference rule could be or should be generated in response to the performed insurance policy operation.

For instance, in the example of FIG. 3, the rule summary view 300 displays conditions of a document inference rule associated with document type “2015C.” The example rule summary view 300 shown in FIG. 3 indicates that the document inference rule associated with document type “2015C” is satisfied if policy operation data 116 associated with an insurance policy indicates that primary use of a vehicle covered by the insurance policy is designated as “work, school, pleasure” or “business,” that less than 50% of the use of the vehicle is for transport of others for compensation, and that a customer associated with the vehicle is affiliated with a Transportation Network Company (TNC) such as Uber® or Lyft®. Accordingly, if policy operation data 116 associated with a particular insurance policy operation performed via the policy management system 102 includes information that meet the conditions of the document inference rule shown in the example of FIG. 3, the document inference system 104 can generate a document inference 110 that identifies document type “2015C.” The document inference 110 may accordingly indicate that an instance of document type “2015C” should be generated by the document generation system 106 in response to performance of the particular insurance policy operation, unless a suppression rule indicates that generation of the instance of document type “2015C” by the document generation system 106 should be suppressed.

The rule summary view 300 can also provide user-selectable options, such as an option to remove the document inference rule, an option to add a document inference rule, or an edit option 302 to edit the document inference rule. For example, if the user selects the edit option 302 to edit the document inference rule, the user interface may display a rule editor view 400 as shown in FIG. 4.

FIG. 4 shows an example of the rule editor view 400 of a user interface associated with the rule manager 124. In some examples, the rule editor view 400 shown in FIG. 4 can be displayed in the user interface of the rule manager 124 when a user selects the edit option 302 to edit a document inference rule as shown in FIG. 3. The rule editor view 400 can present user-selectable options to edit conditions of a document inference rule. For example, the rule editor view 400 can present data descriptions 402 of data types associated with conditions, operators 404 associated with conditions, values 406 of conditions, logical operators 408, parentheses options 410 that can group conditions, and/or other user-selectable options to add, edit, or remove conditions of a document inference rule.

The data descriptions 402 can indicate types of data that may be associated with individual conditions, while corresponding operators 404 and values 406 can indicate when and/or how corresponding information in policy operation data 116 can satisfy those individual conditions. The operators 404 may be relational operators such as less than, less than or equal to, equal to, greater than or equal to, greater than, not equal to, or any other relational operator. Accordingly, the decision engine 118 of the document inference system 104 can determine whether values of data types in policy operation data 116 associated with an operation performed via the policy management system 102, corresponding to the data descriptions 402, satisfy a relationship indicated by the operators 404 and the values 406 associated with the conditions.

The logical operators 408 can be operators such as “AND,” “NOT,” “OR,” or other operators that can define relationships between conditions of the document inference rule. For instance, as shown in the example of FIG. 4, the document inference rule can be satisfied if one of the top two conditions is satisfied, and if both of the bottom two conditions are also satisfied. In other examples, document inference rules 120 may define other types of relationships between conditions of the document inference rules 120.

The parentheses options 410 can also be used to group conditions of a document inference rule. For instance, as shown in the example of FIG. 4, the parentheses options 410 can be used to put parentheses around the top two conditions shown in FIG. 4, such that those conditions can be treated as a single condition within the document inference rule. For example, although the top two conditions are displayed separately in FIG. 4 such that users can view and/or edit the top two conditions separately, the parentheses options 410 used to group the top two conditions can cause the rule manager 124 to otherwise treat the top two conditions as a single condition. For example, because the top two conditions shown in FIG. 4 both indicate values 406 for a “primary vehicle use” data type, and/or because the parentheses options 410 are used to group the top two conditions, the rule summary view 300 shown in FIG. 3 can combine and/or group the two conditions into a single condition indicating that that the document inference rule can be partially satisfied if policy operation data 116 indicates that primary use of a vehicle is designated as “work, school, pleasure” or is designated as “business.”

As shown in FIG. 4, the data descriptions 402 associated with conditions can be expressed in natural language, instead of using attribute names, field names, or other identifiers of corresponding data types or other information that may be used within the policy operation data 116. However, the rule manager 124 can be configured with mappings between the natural language data descriptions 402 and attribute names, field names, or other identifiers of corresponding data types or other information types the policy management system 102 is configured to use within policy operation data 116. In the rule editor view 400, the rule manager 124 can be configured to display the natural language data descriptions 402, rather than the underlying identifiers of the information types that may be used within policy operation data 116. Accordingly, a user who is not familiar with underlying identifiers of information types the policy management system 102 is configured to use within policy operation data 116 can use the rule editor view 400 to add and/or edit conditions of document inference rules 120 based on natural language data descriptions 402 of types of data to be associated with conditions.

However, if a user wants to see the underlying identifiers of information types used within policy operation data 116 that are mapped to the data descriptions 402 of the conditions, the user can select a details option 412 in the rule editor view 400. Upon selection of the details option 412, the user interface of the rule manager 124 can change from the rule editor view 400 to an expanded rule editor view 500 as shown in FIG. 5.

The expanded rule editor view 500 shown in FIG. 5 can display some or all of the same types of information as the rule editor view 400 shown in FIG. 4, but may also show mapping data 502 associated with the data descriptions 402. The mapping data 502 can indicate attribute names, field names, or other identifiers of information types, used within policy operation data 116, that correspond to the natural language data descriptions 402 of data types associated with conditions. For example, although the data descriptions 402 associated with the top two conditions can be “primary vehicle use,” the mapping data 502 can indicate that “primary vehicle use” corresponds to an attribute name of “riskPrimaryUseText” in the policy operation data 116. Accordingly, a user who is not familiar with identifiers of particular types of information used within policy operation data 116 can nevertheless use the corresponding data descriptions 402 presented in the rule editor view 400 or the expanded rule editor view 500 to view and/or edit conditions of the document inference rule.

Similarly, a user can use user-selectable options in the rule editor view 400 or the expanded rule editor view 500 to view and/or edit conditions of a document inference rule, without writing new JSON data or other computer-readable data defining the document inference rule, or editing existing JSON data or other computer-readable data defining the document inference rule. For example, a user who does not have programming experience can use user-selectable options of the rule editor view 400 to edit conditions of a document inference rule that involve the “primary vehicle use” data description, without writing new JSON data or editing existing JSON data that references the underlying “riskPrimaryUseText” attribute name used for that type of data within policy operation data 116.

When a user saves a document inference rule in the rule editor view 400 or the expanded rule editor view 500, the rule manager 124 may translate and/or convert the user-provided definitions of the conditions for the document inference rule into corresponding JSON data, source code, or other computer-readable data that defines the document inference rule. For example, the JSON data, source code, or other computer-readable data generated by the rule manager 124, based on the user-provided definitions of the conditions for the document inference rule, may reference underlying attribute names or other identifiers of data types within policy operation data 116 that map to the user-selected data descriptions 402, instead of the data descriptions 402. The JSON data, source code, or other computer-readable data, generated by the rule manager 124 based on user-provided definitions of the conditions for the document inference rule, may also use computer-readable expressions of operators 404, values 406, logical operators 408, parentheses options 410, and/or other attributes of the document inference rule selected by the user via the rule editor view 400 or the expanded rule editor view 500. The decision engine 118 can use the JSON data, source code, or other computer-readable data that define the document inference rule, generated by the rule manager 124, to apply the document inference rule to policy operation data 116 as described herein.

In some examples, the rule manager 124 can also use information provided in the document view 200, such as information about a document type, a product type, operation types, dates, and/or other information to generate JSON data, source code, or other computer-readable data defining the document inference rule associated with a particular document type. For example, the rule manager 124 may translate information about conditions of a document inference rule provided by a user through the rule editor view 400 or the expanded rule editor view 500 into corresponding JSON data, source code, or other computer-readable data defining the document inference rule. The rule manager 124 may also indicate, in the JSON data, source code, or other computer-readable data defining the document inference rule, that an instance of the type of document indicated in the document view 200 may be generated when the conditions of the document inference rule are satisfied, and/or generate other conditions indicating that the document inference rule can be applied to policy operation data 116 associated with a jurisdiction, product type, operation type, and/or date specified in the document view 200.

Accordingly, based on the example information shown in FIG. 2, the decision engine 118 may determine if conditions of a corresponding document inference rule associated with document type “2015C” are satisfied if other preceding conditions are met, such as that policy operation data 116 is associated with an automobile insurance operation that relevant to the state of Illinois and is associated with new business, a policy change, a renewal, or a reinstatement. The decision engine 118 may determine not to apply the document inference rule associated with document type “2015C” if those preceding conditions are not met, or may determine that the document inference rule associated with document type “2015C” is not met because those preceding conditions are not met.

Overall, FIGS. 2-5 show examples of user interface views associated with the rule manager 124 that users can use to define and/or edit document inference rules 120. The rule manager 124 or other elements of the document inference system 104 can also have other user interface views that allow users to copy document inference rules 120, create templates for documents to be generated if the document inference rules 120 are satisfied, and/or perform other tasks.

As an example, the rule manager 124 can also have user interface view that allows a user to create a new document inference rule for a document type or jurisdiction by creating a copy of an existing document inference rule that can then be edited by the user. For instance, a user may want to create a document inference rule that is similar to the document inference rule for document type “2015C” in association with the state of Illinois, but applies to operations for insurance policies associated with the state of California. The rule manager 124 may have an option for the user to copy definitions of the document inference rule for Illinois into a new document inference rule for California. The user can then use the user interface views shown in FIGS. 2-5 to edit the document inference rule for California, starting with pre-filled information based on the copied document inference rule for Illinois instead of blank information.

As another example, the rule manager 124 or another element of the document inference system 104 can have a user interface view that allows a user to create and/or edit a document template for a type of document that may be generated if a particular document inference rule is satisfied by policy operation data 116. The user interface view may allow users to enter pre-written sections of the document, define conditions or rules indicating how the document generation system 106 is to select and/or arrange pre-written sections of the document, define placeholders within the document to be filled in with values based on a corresponding document payload provided separately by the document inference system 104, and/or otherwise define elements of a document template that can be used by the document generation system 106.

Although FIGS. 2-5 show examples of user interface views associated with a document inference rule 120 having conditions in which a particular type of document may be found to correspond to an insurance policy operation that has been performed via the policy management system 102, the user interface of the rule manager 124 may also have user interface views, options, and/or other elements that allow users to view, create, and/or edit suppression rules. As discussed above, while some document inference rules 120 may define conditions in which document types correspond to performed insurance policy operation, other document inference rules 120 may define conditions in which generation of instances of one or more document types by the document generation system 106 is to be suppressed. Accordingly, a user may use the rule manager 124 to provide definitions of suppression rules, for instance via options and user interface elements in the rule editor view 400. The rule manager 124 may convert such user-provided definitions of suppression rules into JSON data, source code, or other computer-readable data defining the suppression rules that may be applied by the document inference system 104.

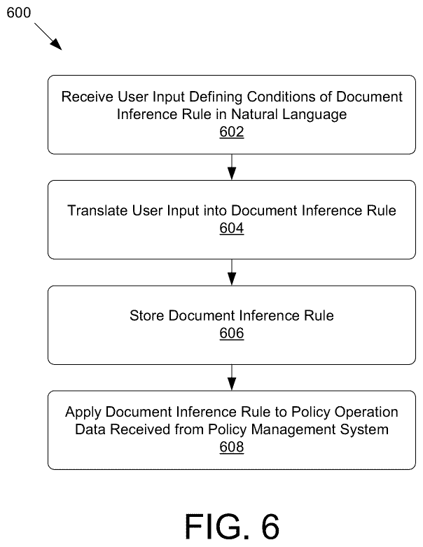

FIG. 6 shows a flowchart illustrating an example method 600 that can be used to generate document inference rules 120 from natural language input provided by users. The method 600 shown in FIG. 6 can be performed by the document inference system 104, which can be executed by at least one computing system. An example system architecture for such a computing system is described below with respect to FIG. 8.

At block 602, the document inference system 104 can receive user input defining one or more conditions of a document inference rule from a user. For example, as shown in FIG. 4, a user interface of the rule manager 124 can display fields, user-selectable options, and/or other elements that allow users to provide user input defining conditions of the document inference rule. The document inference rule can be associated with a particular document type. In some examples, the user-defined rule indicated by the user input received at block 602 can indicate conditions that, if satisfied by policy operation data 116 associated with an insurance policy operation performed via the policy management system 102, indicate that the particular document type corresponds to the insurance policy operation. In these examples, the user-defined rule indicated by the user input may indicate that, if the conditions of the rule are satisfied by the policy operation data 116, an instance of the particular document type may be generated by the document generation system 106 unless document generation is suppressed. In other examples, the user-defined rules indicated by the user input received at block 602 can indicate conditions in which generation of an instance of the particular document type is to be suppressed.

At block 604, the document inference system 104 can translate the user input received at block 602 into a version of the document inference rule that can be applied to policy operation data 116 by the decision engine 118 of the document inference system 104. Although the user input received at block 602 can express conditions of the document inference rule in natural language and may have been provided by a user who does not have programming experience, the rule manager 124 can convert the natural language input into underlying JSON data, source code, or other computer-readable data defining the document inference rule that can be used by the decision engine 118 to automatically evaluate policy operation data 116.

For example, as discussed above with respect to FIG. 5, the rule manager 124 may have mapping data that maps natural language data descriptions 402 of data types that can be entered by users via the rule manager 124 to attribute names, field names, or other identifiers of corresponding data that is used within policy operation data 116. Accordingly, the rule manager 124 can convert natural language descriptions of rule conditions into JSON data, source code, or other computer-readable data that express the rule conditions using data identifiers that are used within the policy operation data 116. Accordingly, although the user that provides the user input at block 602 may not have programming experience or be familiar with a schema of identifiers used within policy operation data 116, the user can provide natural language input to define a document inference rule at block 602, and the document inference system 104 can translate the natural language input into a version of the document inference rule that the decision engine 118 can apply to policy operation data 116.

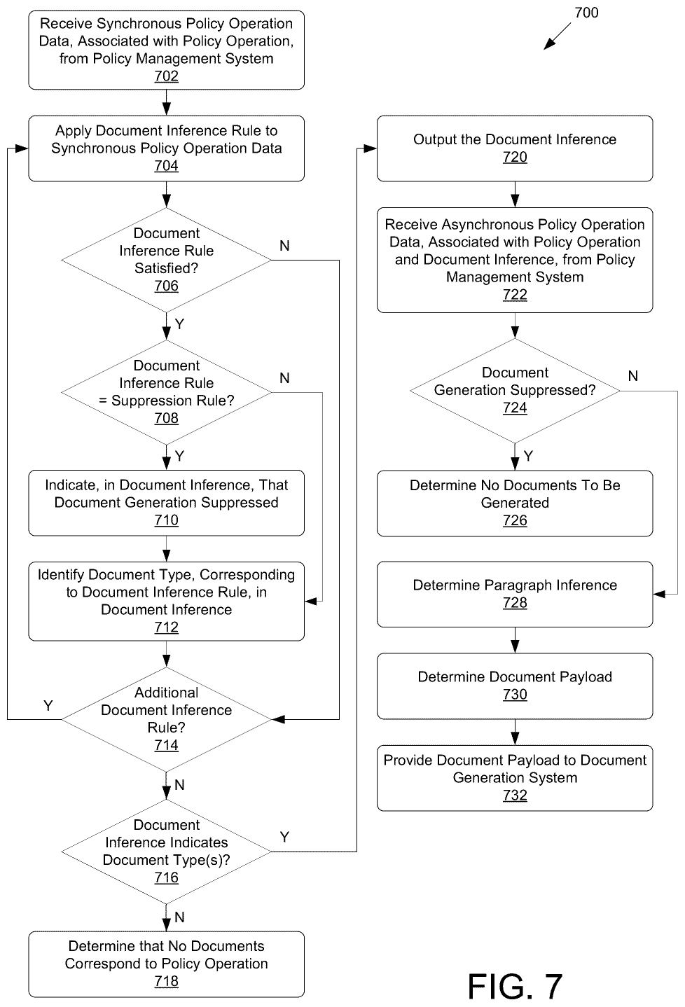

At block 606, the document inference system 104 can store the version of the document inference rule, translated at block 604 from user-provided natural language input, in a database or other repository of document inference rules 120. At block 608, the document inference system 104 can apply the document inference rule to policy operation data 116 received from the policy management system 102, for example as discussed below with respect to FIG. 7.

FIG. 7 shows a flowchart illustrating an example method 700 that can be used to generate a document inference 110, and any corresponding documents, in response to an insurance policy operation performed within the policy management system 102. The method 700 shown in FIG. 7 can be performed by the document inference system 104, which can be executed by at least one computing system. An example system architecture for such a computing system is described below with respect to FIG. 8.

At block 702, the document inference system 104 can receive synchronous policy operation data 116 from the policy management system 102. The synchronous policy operation data 116 can be associated with an insurance policy operation performed within the policy management system 102, and may be sent by the policy management system 102 to the document inference system 104 as a message or other notification as part of, or substantially immediately after, the insurance policy operation. For example, the policy management system 102 may output or send the synchronous policy operation data 116 within a threshold period of time after completing performance of a corresponding insurance policy operation. The synchronous policy operation data 116 can indicate a type of the insurance policy operation, attributes of the insurance policy operation, metadata about the insurance policy operation, and/or other information about the insurance policy operation.

At block 704, the document inference system 104 can apply a document inference rule to the synchronous policy operation data 116 received at block 702. The document inference rule can be associated with a type of document. The document inference rule can be defined by JSON data, source code, or other computer-readable data indicating conditions that, if satisfied by the synchronous policy operation data 116, indicate that the insurance policy operation performed via the policy management system 102 corresponds to the type of document associated with the document inference rule. Accordingly, at block 706, the document inference system 104 can determine whether the synchronous policy operation data 116 received at block 702 satisfies the conditions of the document inference rule.

If the document inference rule applied at block 704 is satisfied by the synchronous policy operation data 116 (Block 706—Yes), at block 708 the document inference system 104 can determine whether the satisfied document inference rule is a suppression rule. Such a suppression rule may indicate that, if corresponding conditions are satisfied, generation of an instance of a document type indicated in the document inference 110 is to be suppressed. Accordingly, if the satisfied document inference rule is a suppression rule (Block 708—Yes), at block 710 the document inference system 104 can indicate in a document inference 110 that the document generation system 106 should not actually generate an instance of a particular type of document that corresponds to the suppression rule. For example, the document inference system 104 can include a suppression indicator, associated with the particular type of document, in the document inference 110.

If the document inference rule determined to be satisfied at block 706 is not a suppression rule (Block 708—No), at block 712 the document inference system 104 can include an indication of the document type associated with the satisfied document inference rule in a document inference 110 generated by the document inference system 104 in response to the insurance policy operation. As noted above, satisfaction of a suppression rule may in some situations cause the document inference system 104 to add a suppression indicator to the document inference 110 in association with a document type identified in the document inference 110.

If the document inference rule applied at block 704 is not satisfied by the synchronous policy operation data 116 (Block 706—No), the document inference system 104 can omit an indication of the document type associated with that document inference rule from the document inference 110.

At block 714, the document inference system 104 can determine whether any additional document inference rules 120 are to be applied to the synchronous policy operation data 116 received at block 702. For example, there may be other document inference rules associated with the same document type or different document types, and/or suppression rules associated with those document types, that have not yet been applied.

If there is another document inference rule to apply (Block 714—Yes), the document inference system 104 can return to block 704 and apply the document inference rule to the synchronous policy operation data 116. Accordingly, the document inference system 104 may add a corresponding document type to the document inference 110 at block 712 if the synchronous policy operation data 116 satisfies the conditions of the document inference rule, or may add a suppression indicator to the document inference 110 at block 710 if the applied document inference rule is a suppression rule indicating that actual generation of a corresponding document is to be suppressed. The document inference system 104 can accordingly loop through blocks 704 through 712 until no more document inference rules 120 are to be applied to the synchronous policy operation data 116.

If there are no more document inference rules 120 to apply (Block 714—No), the document inference system 104 can determine at block 716 whether the document inference 110 identifies one or more document types that correspond to the insurance policy operation. If the synchronous policy operation data 116 did not satisfy any document inference rules 120 indicating document types that correspond to the insurance policy operation performed via the policy management system 102, such that the document inference 110 does not identify any types of documents corresponding to satisfied document inference rules (Block 716—No), the document inference system 104 can determine at block 718 that no document types correspond to the insurance policy operation, and method 700 can end.

However, if the synchronous policy operation data 116 satisfied at least one of the document inference rules 120, such that the document inference 110 identifies one or more types of documents corresponding to the satisfied document inference rules (Block 716—Yes), the document inference system 104 can output the document inference 110 at block 720. For example, at block 720 the document inference system 104 may provide the document inference 110 to the policy management system 102 and/or the document generation system 106. The document inference 110 output at block 720 may identify one or more types of documents that correspond to the insurance policy operation. In some examples, the document inference 110 output at block 720 may also include suppression indicators indicating whether or not generation of instances of any of the identified types of documents is being suppressed.

At block 722, the document inference system 104 can receive asynchronous policy operation data 116, associated with the insurance policy operation and/or the document inference 110, from the policy management system 102. For example, if the document inference system 104 provided the document inference 110, indicating one or more types of documents that correspond to the insurance policy operation, the policy management system 102 may publish additional information about the insurance policy operation as asynchronous policy operation data 116, for instance in a message table or other data sharing system. The document inference system 104 can accordingly access the message table or other data sharing system to obtain the asynchronous policy operation data 116 associated with the insurance policy operation.

At block 724, the document inference system 104 can determine whether generation of instances of all the types of documents indicated by the document inference 110 is to be suppressed, based on suppression indicators in the document inference 110 and/or based on asynchronous policy operation data 116 received at block 718. In some examples, the document inference system 104 may determine whether to add or adjust suppression indicators in the document inference 110 based on asynchronous policy operation data 116 received at block 718. For example, the document inference 110 output at block 720 may identify a particular type of document that, based on the synchronous policy operation received at block 702, was determined to correspond with the insurance policy operation. However, if additional asynchronous policy operation data 116 received at block 722 indicates that generation of an instance of that particular type of document should be suppressed, the document inference system 104 may add a corresponding suppression indicator to a version of the document inference 110 that is provided to the document generation system 106.

If the document inference system 104 determines that generation of all of the types of documents indicated by the document inference 110 is to be suppressed (Block 724—Yes), the document inference system 104 may determine at block 726 that no documents are to be generated by the document generation system 106, and method 700 can end. However, if the generation of at least one of the types of documents indicated by the document inference 110 is not being suppressed (Block 724—No), the document inference system 104 may move to block 728.

At block 728, the document inference system 104 can determine one or more paragraph inferences, and/or other content inferences, associated with the types of documents indicated by the document inference 110. For example, the document inference system 104 can use document inference rules 120 and/or other types of rules to determine, based on the synchronous policy operation data 116 received at block 702, the asynchronous policy operation data 116 received at block 722, and/or other policy data 112 retrieved from the policy management system 102, which paragraphs or other content elements to include in instances of documents that correspond to the document types identified in the document inference 110.

At block 730, the document inference system 104 can determine a document payload 122 for individual types of documents indicated by the document inference 110. The document payloads 122 can indicate the paragraph inferences, and/or other content inferences, determined at block 728. The document inference system 104 can also use document inference rules 120 and/or other types of rules to determine, based on the synchronous policy operation data 116 received at block 702, the asynchronous policy operation data 116 received at block 722, and/or other policy data 112 retrieved from the policy management system 102, content values to be expressed within instances of the corresponding types of documents, and can include the content values in the document payloads 122. Accordingly, the document payloads 122 can identify particular content elements, such as particular paragraphs and/or other content elements, particular values to be expressed in documents, and/or other types of content information.

At block 732, the document inference system 104 can provide the document payloads 122 associated with corresponding types of documents indicated by the document inference 110 to the document generation system 106. The document generation system 106 can accordingly use the document payloads 122 provided at block 732 to generate instances of the types of documents, indicated by the document inference 110, in association with the insurance policy operation. In some examples, if a suppression indicator in the document inference 110 indicates that the document generation system 106 should not actually generate an instance of a type of document identified in the document inference 110, the document generation system 106 may avoid generating an instance of that type of document despite the indication of the document type in the document inference 110.

In some examples, the document inference system 104 may provide the document payloads 122 as part of the document inference 110, such that the document inference system 104 waits until block 732 to provide the document inference 110, containing one or more document payloads 122, suppression indicators, and/or indications of one or more corresponding document types, to the document generation system 106. In other examples, the document inference system 104 may provide the document inference 110 to the document generation system 106 at block 720, and later provide one or more corresponding document payloads 122 to the document generation system 106 at block 732, for instance after the document inference system 104 receives asynchronous policy operation data 116 published by the policy management system 102 at block 722 and determines corresponding paragraph inferences, suppression indicators, and/or document payloads at blocks 728 and 730.

FIG. 8 shows an example system architecture 800 for a computing system 802 that can execute one or more elements of the system 100 described herein. For example, the computing system 802 may execute one or more portions of the system 100, such as the policy management system 102, the document inference system 104, and/or the document generation system 106. The computing system 802 can include one or more servers, computers, or other types of computing devices. Individual computing devices of the computing system 802 may have the system architecture 800 shown in FIG. 8, or a similar system architecture.

In some examples, the computing system 802 may be, or include, a user device, such as a laptop or desktop computer, tablet computer, mobile device, or other computing device that a user can use to access elements of the system 100 that are executed remotely by other computing systems or computing devices, for instance by accessing web pages or other systems that provide user interfaces of the policy management system 102 and/or document inference system 104. In other examples, the computing system 802 may be, or include, a server or other computing device that may host and/or execute front-end and/or back-end elements of the policy management system 102, the document inference system 104, and/or the document generation system 106. In these examples, a user may use a user device to access web pages or other systems that provide user interfaces of the policy management system 102 and/or document inference system 104 executed by the computing system 802.

In some examples, elements of the system 100 can be distributed among, and/or be executed by, multiple computing systems or devices similar to the computing system 802 shown in FIG. 8. For example, the document inference system 104 may execute on a different computing device or system than the policy management system 102. The computing system 802 may, in some examples, be part of a cloud computing environment or other computing environment that hosts and/or executes one or more elements of the system 100. For instance, a cloud computing environment may include multiple servers or other computing devices that can host elements and/or instances of the system 100, such as one or more elements and/or instances of the document inference system 104. In some examples, the servers or other computing devices of such a cloud computing environment may use one or more virtual machines, containers, and/or other systems to execute one or more elements and/or instances of the system 100.

The computing system 802 can include memory 804. In various examples, the memory 804 can include system memory, which may be volatile (such as RAM), non-volatile (such as ROM, flash memory, etc.) or some combination of the two. The memory 804 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing system 802. Any such non-transitory computer-readable media may be part of the computing system 802.

The memory 804 can store one or more types of data, computer-executable instructions associated with software elements, firmware elements, or other executable elements, and/or other information. The memory 804 can store computer-executable instructions and data associated with one or more elements of the system 100. For example, the memory 804 can store computer-executable instructions and data associated with one or more elements of the document inference system 104, such as the decision engine 118, the document inference rules 120, and/or the rule manager 124.

The memory 804 can also store other modules and data 806, such as other modules and/or data that can be utilized by the computing system 802 to perform or enable performing any action taken by the computing system 802. Such other modules and data 806 can include a platform, operating system, and/or applications, as well as data utilized by the platform, operating system, and/or applications.

The computing system 802 can also have processor(s) 808, communication interfaces 810, a display 812, output devices 814, input devices 816, and/or a drive unit 818 including a machine readable medium 820.

In various examples, the processor(s) 808 can be a central processing unit (CPU), a graphics processing unit (GPU), both a CPU and a GPU, or any other type of processing unit. Each of the one or more processor(s) 808 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 808 may also be responsible for executing computer applications stored in the memory 804, which can be associated with common types of volatile (RAM) and/or nonvolatile (ROM) memory.

The communication interfaces 810 can include transceivers, modems, interfaces, antennas, telephone connections, and/or other components that can transmit and/or receive data over networks, telephone lines, or other connections. In some examples, the communication interfaces 810 can be used by one or more elements of the document inference system 104 to interact with the policy management system 102 and document generation system 106, for to receive and/or access policy operation data 116 from the policy management system 102, provide the document inference 110 to the policy management system 102 and/or the document generation system 106, and/or to provide the document payload 122 to the document generation system 106.

The display 812 can be a liquid crystal display, or any other type of display commonly used in computing devices. For example, a display 812 may be a touch-sensitive display screen, and can then also act as an input device or keypad, such as for providing a soft-key keyboard, navigation buttons, or any other type of input.

The output devices 814 can include any sort of output devices known in the art, such as the display 812, speakers, a vibrating mechanism, and/or a tactile feedback mechanism. Output devices 814 can also include ports for one or more peripheral devices, such as headphones, peripheral speakers, and/or a peripheral display.

The input devices 816 can include any sort of input devices known in the art. For example, input devices 816 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 820 can store one or more sets of instructions, such as software or firmware, that embodies any one or more of the methodologies or functions described herein. The instructions can also reside, completely or at least partially, within the memory 804, processor(s) 808, and/or communication interface(s) 810 during execution thereof by the computing system 802. The memory 804 and the processor(s) 808 also can constitute machine readable media 820.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method, comprising:
receiving, by a document inference system executed by a computing system, user input indicating a natural language definition of a condition corresponding to a document type;
converting, by the document inference system, the natural language definition of the condition into a document inference rule that is applicable by a decision engine of the document inference system;
receiving, by the document inference system, operation data associated with an operation performed within a management system that is separate from the document inference system;
determining, by the decision engine of the document inference system, that the operation data satisfies the document inference rule associated with the document type; and
generating, by the document inference system, based on determining that the operation data satisfies the document inference rule, a document inference that identifies the document type.

2. The computer-implemented method of claim 1, further comprising providing, by the document inference system, the document inference to a document generation system, wherein the document inference causes the document generation system to generate an instance of the document type.

3. The computer-implemented method of claim 1, wherein:
the operation data comprises synchronous operation data sent as a notification from the management system to the document inference system as part of, or substantially immediately following, performance of the operation within the management system, and
the document inference is generated in response to determining that the synchronous operation data satisfies the document inference rule.

4. The computer-implemented method of claim 3, further comprising:
providing, by the document inference system at a first time, the document inference to the management system;
accessing, by the document inference system at a second time, asynchronous operation data from the management system that comprises additional information associated with the operation performed within the management system;
generating, by the document inference system, a document payload indicating at least one content element for an instance of the document type based on at least one of the synchronous operation data or the asynchronous operation data; and
providing, by the document inference system, the document payload to a document generation system as part of, or in addition to, the document inference,
wherein the document inference causes the document generation system to generate the instance of the document type based at least in part on the document payload.

5. The computer-implemented method of claim 4, wherein:
the asynchronous operation data is published to a message table by the management system, and
the document inference system accesses the asynchronous operation data from the message table.

6. The computer-implemented method of claim 1, further comprising providing, by the document inference system, the document inference to the management system, wherein the document inference causes the management system to:
display, in a user interface, a placeholder indicating that an instance of the document type will be generated by a document generation system in response to the operation, and
replace the placeholder in the user interface, by presenting the instance of the document type in the user interface, in response to generation of the instance of the document type by the document generation system.

7. The computer-implemented method of claim 1, further comprising providing, by the document inference system, the document inference to the management system, wherein:
the document inference causes the management system to provide additional operation data to the document inference system,
the additional operation data is associated with the operation, and
the additional operation data corresponds to the document type.

8. The computer-implemented method of claim 1, further comprising:
determining, by the document inference rule, that a suppression rule associated with the document type is satisfied;
adding, by the document inference rule, a suppression indicator associated with the document type to the document inference; and
providing by the document inference system, the document inference to the management system,
wherein the document inference and the suppression indicator causes the management system to display, in a user interface, a notification that the document type corresponds to the operation but that generation of an instance of the document type is being suppressed.

9. The computer-implemented method of claim 1, wherein a user interface of the document inference system presents user options configured to allow a user to provide the user input and define the natural language definition of the condition associated with the document inference rule.

10. The computer-implemented method of claim 1, wherein converting the natural language definition of the condition into the document inference rule comprises:
using, by the document inference system, mapping data to convert natural language descriptions of data types used within the natural language definition to corresponding data identifiers, defined by a schema, of data elements within the operation data used by the management system.

11. The computer-implemented method of claim 1, wherein the computing system that executes the document inference system is different from a second computing system that executes the management system.

12. A computing system, comprising:
one or more processors; and
memory storing computer-executable instructions associated with a document inference system that, when executed by the one or more processors, cause the one or more processors to:
receive, from a management system separate from the document inference system, operation data associated with an operation performed within the management system;
determine that the operation data satisfies conditions of a document inference rule associated with a document type;
generate, in response to determining that the operation data satisfies the conditions of the document inference rule, a document inference that identifies the document type; and
provide the document inference to at least one of:
the management system, or
a document generation system configured to generate an instance of the document type in response to the operation performed within the management system.

13. The computing system of claim 12, wherein:
the operation data comprises synchronous operation data sent as a notification from the management system to the document inference system as part of, or substantially immediately following, performance of the operation within the management system, and
the computer-executable instructions further cause the one or more processors to:
access asynchronous operation data, from the management system, that comprises additional information associated with the operation performed within the management system;
generate a document payload indicating at least one content element for the instance of the document type based on at least one of the synchronous operation data and the asynchronous operation data; and
provide the document payload to the document generation system as part of, or in addition to, the document inference.

14. The computing system of claim 12, wherein the computer-executable instructions further cause the one or more processors to:
receive user input associated with a natural language definition of the conditions associated with the document inference rule; and
translate the natural language definition of the conditions into the document inference rule that is applicable to the operation data by the document inference system.

15. The computing system of claim 14, wherein the computer-executable instructions further cause the one or more processors to display a user interface of the document inference system, the user interface presenting user options configured to allow a user to provide the user input and define the natural language definition of the conditions associated with the document inference rule.

16. The computing system of claim 14, wherein translating the natural language definition of the conditions into the document inference rule comprises:
using mapping data to convert natural language descriptions of data types used within the natural language definition to corresponding data identifiers, defined by a schema, of data elements within the operation data used by the management system.

17. One or more non-transitory computer-readable media storing computer-executable instructions associated with a document inference system that, when executed by one or more processors, cause the one or more processors to:
receive, from a management system separate from the document inference system, operation data associated with an operation performed within the management system;
determine that the operation data satisfies conditions of a document inference rule associated with a document type;
generate, in response to determining that the operation data satisfies the conditions of the document inference rule, a document inference that identifies the document type; and
provide the document inference to at least one of:
the management system, or
a document generation system configured to generate an instance of the document type in response to the operation performed within the management system.

18. The one or more non-transitory computer-readable media of claim 17, wherein:
the operation data comprises synchronous operation data sent as a notification from the management system to the document inference system as part of, or substantially immediately following, performance of the operation within the management system, and
the computer-executable instructions further cause the one or more processors to:
access asynchronous operation data, from the management system, that comprises additional information associated with the operation performed within the management system;
generate a document payload indicating at least one content element for the instance of the document type based on at least one of the synchronous operation data and the asynchronous operation data; and
provide the document payload to the document generation system as part of, or in addition to, the document inference.

19. The one or more non-transitory computer-readable media of claim 17, wherein the computer-executable instructions further cause the one or more processors to:
receive user input associated with a natural language definition of the conditions associated with the document inference rule; and
translate the natural language definition of the conditions into the document inference rule that is applicable to the operation data by the document inference system.

20. The one or more non-transitory computer-readable media of claim 17, wherein:
the computer-executable instructions further cause the one or more processors to:
determine that a suppression rule associated with the document type is satisfied; and
add a suppression indicator associated with the document type to the document inference, and
the suppression indicator suppresses generation of the instance of the document type by the document generation system.
